(19) United States
(12) Patent Application Publication
(10) Pub. No.: US 2025/0371122 A1
(43) Pub. Date: Dec. 4, 2025

(54) METHOD, DEVICE AND COMPUTER PROGRAM AIDING ACCESS TO A SERVICE

(71) Applicant: LA FRANÇAISE DES JEUX, BOULOGNE-BILLANCOURT (FR)

(72) Inventors: Christophe AMATE, SAUSSET LES PINS (FR); Fanny SYLVESTRE, CLAMART (FR); Côme BOUQUET, IVRY SUR SEINE (FR)

(21) Appl. No.: 18/870,671

(22) PCT Filed: May 26, 2023
(86) PCT No.: PCT/FR2023/050741

§ 371 Date: Dec. 1, 2024

(30) Foreign Application Priority Data
Jun. 3, 2022 (FR) FR2205357

(51) Int. Cl. G06F 21/32; G06V 40/16

(52) U.S. Cl. CPC G06F 21/32; G06V 40/172

(57) ABSTRACT

A method for a computer aiding access to a service by a device provided with data acquirer and communicator. The service being accessible only subject to at least one condition. After having obtained identification data of a user, from the data acquirer and from an identification document, the identification data comprising at least one photograph of the user and a characteristic of the user, are transmitted to a validation system. In response, a validation confirming the validity of the identification document is received. A digital certificate comprising a photograph of the user and the characteristic obtained is then created and stored. The digital certificate configured to be used to obtain the characteristic and the photograph. The photograph is compared to a real face to validate the characteristic. The service being accessed in response to the validation of the characteristic.

The invention relates to the field of access to services, products or places, in particular access to services such as games, for example to assist a user to access a game according to some of their characteristics, in particular according to their age.

In many situations, access to services, products or places is subject to one or more particular criteria, for example a minimum age of the user wishing to access a particular service, product or place. Thus, by way of illustration, when a player wishes to make a sporting bet, for example to bet a few euros or tens of euros on the result of a football match, a retailer may, in a retail outlet, at the moment of recording the bet, request evidence of identity if they have doubts about the age of the player (bets are generally reserved for adults). Such a check does however have many drawbacks. In particular, it takes time, which may lead to discontent on the part of the customers of the retailer, obliges the players to reveal their identity and may, in some situations, be vexatious. These constraints sometimes lead players or, more generally, users, who might access a service, a product or place deciding not to do so.

There is therefore a need for simplify access to some characteristics of a user, by an operator controlling access to services, products or places, in order to allow simple, rapid, effective and non-invasive verification in terms of access to personal data, to decide to give access or not to the service, products or place requested.

The present invention aims in particular to solve these problems.

### DESCRIPTION OF THE INVENTION

For this purpose, the invention proposes a method, a device and a computer program aiding access to services or products.

A method is thus proposed for a computer aiding access to a service by means of a device provided with data-acquisition means and communication means, said service being accessible only subject to at least one condition, the method comprising,
obtaining, by said device, identification data of a user, from said acquisition means of said device and from an identification document, said identification data comprising at least one photograph of said user and a characteristic of said user,
transmitting, by said device, said identification data obtained to a validation system,
in response to said transmission of said identification data, receiving, by said device, validation data confirming the validity of said identification document,
in response to said reception of validation data, creating and storing, by said device, a digital certificate, said digital certificate comprising at least one photograph of said user and said characteristic obtained,
said digital certificate being used to obtain said characteristic and said photograph, said photograph being able to be compared with a real face validating said characteristic, said service being accessed in response to the validation of said characteristic.

The method according to the invention thus makes it possible to assist a user to access a service, a product or a place and/or an operator give access to a service, a product or a place, by facilitating checking certain characteristics of the user, for example their age, in a simple, rapid and secure manner, and preserving their anonymity. Such services, products and places are, for example, games, in particular sporting bets, alcoholic drinks, cigarettes, discotheques, etc.

According to particular embodiments, the method furthermore comprises obtaining, by said device, a current photograph of said user, said current photograph being obtained from said acquisition means of said device, said photograph of said digital certificate being said current photograph.

Still according to particular embodiments, the method furthermore comprises a transmission, by said device, of said current photograph to said validation system to verify that said user is the owner of said identity document.

Still according to particular embodiments, the method furthermore comprises a step of compression and/or encoding, by said device, of said photograph and of said characteristic of said digital certificate.

Still according to particular embodiments, the method furthermore comprises a step of calculation, by said device, of a signature based on said photograph and/or said characteristic of said digital certificate, said signature being added to said digital certificate.

Still according to particular embodiments, the method furthermore comprises
obtaining, by said device, data relating to said service,
encoding, by said device, said data obtained relating to said service and data of said digital certificate in a code for giving access to said service, and
transmitting, by said device, said access code to a terminal of an operator, said terminal being configured to decode data of said access code and to display at least said photograph of said digital certificate and information obtained from said characteristic of said digital certificate.

Still according to particular embodiments, the method furthermore comprises the transmission of said access code comprises the display of said access code on said device.

Still according to particular embodiments, the method furthermore comprises
receiving, by said terminal, said access code,
obtaining, in said terminal, said photograph of said digital certificate encoded in said access code,
displaying, by said terminal, said photograph obtained of said digital certificate encoded in said access code and said information obtained from said characteristic of said digital certificate,
in response to a validation, on said terminal, of an operator following said display of said photograph obtained of said digital certificate encoded in said access code and said information obtained from said characteristic of said digital certificate, providing access to said service to said user.

Another object of the invention is a device configured to implement the method described above or part thereof. The advantages procured by this device are similar to those described previously with regard to the method.

A computer program, implementing all or part of the method described above, installed on pre-existing equipment, is in itself advantageous, provided that it makes it possible to access and select, easily and quickly, an event liable to interest a user.

Thus the present invention also relates to a computer program including instructions for implementing the method previously described, in whole or in part, when this program is executed by a processor.

This program can use any programming language (for example an object language or other) and be in the form of an interpretable source code, a partially compiled code or a fully compiled code.

Another aspect relates to a non-transient storage medium of a program executable by computer, comprising a set of data representing one or more programs, said one or more programs comprising instructions for, when said one or more programs are executed by a computer comprising a processing unit operationally coupled to memory means and to an input/output interface module, executing all or part of the method described above.

### BRIEF DESCRIPTION OF THE DRAWINGS

Other features, details and advantages of the invention will emerge from the reading of the following detailed description. The latter is purely illustrative and must be read with regard to the accompanying drawings, in which:

FIG. 1 illustrates an example of an environment in which the invention can be implemented according to particular embodiments;

FIG. 2 illustrates an example of steps of a method for creating a digital certificate for subsequently assisting a user to access a service and/or an access provider to give access to a service, according to particular embodiments of the invention;

FIG. 3 illustrates an example of steps of a method for using a digital certificate for accessing a game, according to particular embodiments of the invention, implemented in a device of a player;

FIG. 4 illustrates an example of steps of a method for using a digital certificate for giving access to a game, example a sporting bet, according to particular embodiments of the invention, implemented in a terminal of an operator, for example a terminal of a retailer in a retail outlet;

FIG. 5 illustrates an example of a device of a player wishing to register participation in a game;

FIG. 6 illustrates an example of a screen of a terminal of an operator, for example a terminal of a retailer of a retail outlet, used for registering participation in a game; and

FIG. 7 illustrates an example of a device that can be used for implementing, at least partially, embodiments of the invention, in particular steps described with reference to FIGS. 2 and 3.

### DETAILED DESCRIPTION

According to particular embodiments of the invention, access to a service, a product or a place is implemented in two phases. During a first phase, a digital certificate is created by a user by means of a device such as a smartphone or a tablet. This digital certificate comprises for example a photograph of the user and a characteristic allowing access to the service, to the product or to the place, for example the date of birth of the user that can be used to determine the age of the user when the latter wishes, in a second phase, to access a product, a service or a place. The digital certificate can be created from an identity document, for example an identity card, which is preferably checked in a system (for example a server) of a trusted third party and from which information used for creating the digital certificate is extracted. The photograph of the user stored in the digital certificate can be obtained from a device used for creating the digital certificate and used for checking the user by comparison with a photograph of the identity document. The digital certificate is preferably signed to reduce risks of fraud. It is stored in a device of the user, for example in the device used for creating the digital certificate.

When the user wishes to access a service, a product or a place, they use their digital certificate to provide information, for example their photograph and their date of birth, to the operator giving access to the service, to the product or to the place. The photograph can be displayed on the device to enable the operator giving access to the service, to the product or to the place to verify that the digital certificate is indeed the one of the bearer of the device (by comparing the photograph with the face of the user) and to calculate their age (from the date of birth and the present date). Alternatively or in addition, the digital certificate can also be transmitted to a device, for example a terminal, of the operator giving access to the service, to the product or to the place, which can then extract the information therefrom to verify that the user can access the service or product requested. Alternatively, the digital certificate can be used transparently for the user, for example by adding it or adding some of the elements thereof (e.g. the photograph, the date of birth of the user and the signature of the digital certificate) to game data, for example sporting-bet data. The game data comprising the digital certificate or elements of the digital certificate can be encoded in participation code (or registration code or, more generally, access code) form, for example a QR code or a barcode, which is presented to the operator giving access to the service, to the product or to the place. After having scanned the QR code on the barcode with a reading device connected to a terminal, the photograph and an indication of majority can be displayed on the terminal to enable the operator giving access to the service, to the product of to the place to validate access to the service, to the product of the place, for example to record a sporting bet.

For reasons of clarity and concision, the examples that follow relate mainly to access to services, in particular games such as sporting bets. However, these examples are not limitative and steps similar to those described can be implemented to facilitate access to all types of controlled services, in particular access to products and places.

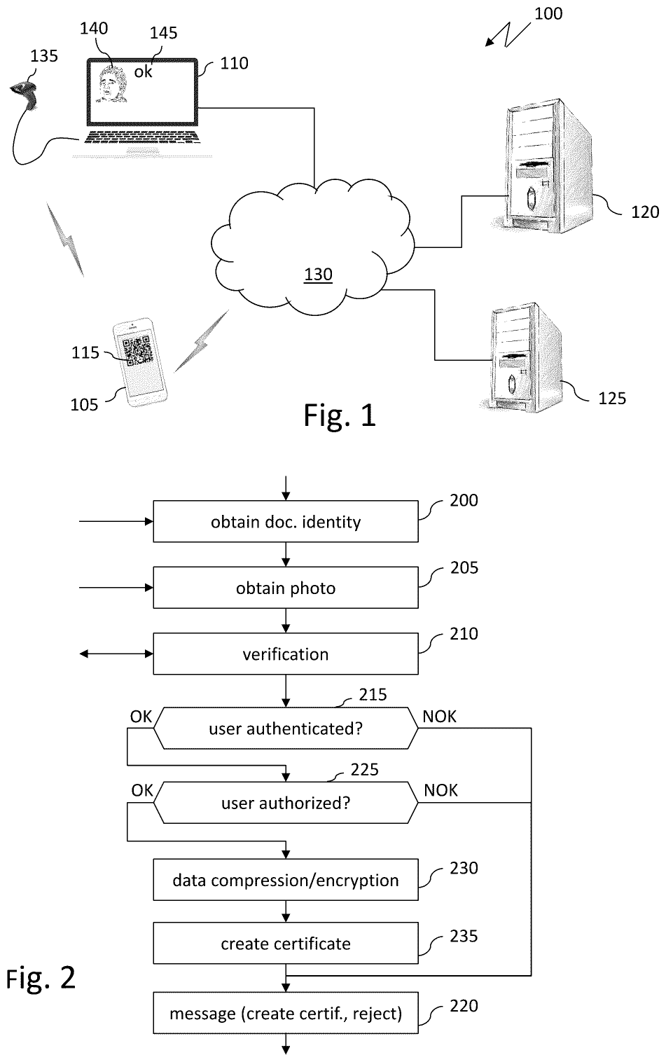

FIG. 1 illustrates an example of an environment 100 in which the invention can be implemented according to particular embodiments. As depicted, a user such as a player can use a device 105 such as a smartphone or a tablet to assist them in accessing a service or product, for example to participate in sporting bets. This service or product may be offered by an operator via a retailer provided with a terminal 110, for example a retailer in a retail outlet. The device of the user is advantageously provided with data-capture means (not shown), for example a photograph or video sensor, with a screen for displaying data, for example data encoded in the form of QR codes such as the QR code 115 or barcodes, and with communication means (not shown) for exchanging data with one or more remote servers, for example the servers 120 and 125, via a communication network 130.

The terminal 110 used by the retailer is preferably provided with data-acquisition means 135, for example optical reading means adapted to read QR codes or barcodes, with a screen for displaying data, in particular a photograph received from the device 105 and data characterizing the user or indicative of a characteristic of the user, for example an indication of majority 145. The terminal 110 can furthermore comprise communication means (not shown), for example for recording the participation of the user in a game such as a sporting bet.

The communication means of the device 105 and/or of the terminal 110 are wire or wireless communication means, for example communication means in accordance with the WiFi, Bluetooth or Ethernet standards (WiFi and Bluetooth are trademarks). Likewise, the servers 120 and 125 comprise communication means. Once again, it may for example be a case of communication means in accordance with the Wi-Fi, Bluetooth or Ethernet standards. The communication means of these devices can rely on standard communication protocols, for example the TCP/IP protocol (the initialism for Transmission Control Protocol/Internet Protocol).

By way of illustration, the server 120 can be a server of a game operator and the server 125 can be a verification server of a third party.

Examples of steps implemented in the device 105, the terminal 110 and the server 120 illustrated on FIG. 1 are described with reference to FIGS. 2 to 4.

FIG. 2 illustrates an example of steps of a method for creating a digital certificate for subsequently assisting a user to access a service and/or an access provider to give access to a service, according to particular embodiments of the invention. The steps illustrated on FIG. 2 are, for example, implemented in the device 105 of FIG. 1. These steps can be implemented in an autonomous module or in a module of a particular application relating to at least one service that may be requested by the user, for example a game application such as the application known by the name “Parions Sport Point de Vente” of the company La Française Des Jeux (La Française Des Jeux is a trademark). This module for creating a digital certificate can be executed at the request of the user or automatically, for example the first time that they launch the application comprising this module.

As illustrated, the object of a first step (step 200) is to obtain a photograph or a video sequence of at least part of an identity document of the user, for example a photograph of an identity card. This photograph or this video sequence can be obtained by means of a video sensor of the device of the user, for example their smartphone. It comprises a photograph of the user and a characteristic of the user making it possible to determine whether or not they can access a service or product, for example the date of birth. It furthermore preferably comprises verification means, for example physical data and/or indicators, enabling a third party to make checks (for example checks similar to those made to check banknotes).

In a following or preceding step (step 205), a photograph or video sequence of the user is obtained. This photograph or this video sequence is preferably obtained by means of a video sensor of the device of the user. It consists of a current photograph or video sequence of the user.

A check of the identity document is next here made (step 210). It comprises for example the transmission of the photograph or the video sequence of at least part of the identity document to a server of a trusted third party that will, for example, check the presence of certain indicators, compare information appearing on the identity document with results of calculations made from other information appearing on the identity document, etc. In response to the transmission of the photograph or of the video sequence of at least part of the identity document, the device of the user receives, for example from the trusted third party, an indication of validation or of non-validation. This step of checking the identity document may also comprise a step the purpose of which is to check that the user is indeed the owner of the identity document. This check can be made by comparing the current photograph (or an extract of the video sequence) of the user with the one appearing on the identity document. For these purposes, the current photograph of the user, the video sequence or an extract of the latter can be transmitted to the server of the trusted third party. This process of checking an identity document can use a solution known to a person skilled in the art, for example one of the solutions known by the names Yoti, Idcheck and Ubble (Yoti, Idcheck and Ubble are trademarks).

If the identity document is not validated (step 215), the procedure for creating a digital certificate is here ended and the user is preferably warned thereof, for example by means of a message displayed on the screen of the device (step 220). If, on the other hand, the identity document is validated, the object of a following optional step is to determine whether the user complies with predetermined rules (step 225), for example if they are not prohibited games. If these rules are not satisfied, the procedure for creating a digital certificate is ended and once again the user is preferably warned thereof, for example by means of a message displayed on the screen of the device (step 220). If, on the other hand, these rules are satisfied, the data that are to appear in the digital certificate are obtained and preferably compressed and/or encrypted (step 230). These data are for example the current photograph (or the video sequence or an extract thereof) of the user and one or more data appearing on the identity document, for example the date of birth of the user. According to particular embodiments, a compression algorithm allowing strong compression is used to allow coding of the certificate in the form of a participation code, for example a QR code or a barcode, or a part of such a code. The compression algorithm used for compressing a photograph of a face of a user is for example based on the one described in the document entitled “Scalable facial image compression with deep feature reconstruction” of S. Wang et al., IEEE International Conference on Image Processing (ICIP), 2019.

A digital certificate is next created (step 235). It comprises the data obtained, where applicable, compressed and/or encrypted. According to particular embodiments, it furthermore comprises a signature, for example a result of a hash function applied to the data obtained (compressed and/or encrypted or not). The digital certificate may also comprise an indication relating to its origin, for example an indication relating to the module used for generating it.

The digital certificate obtained is advantageously stored locally, in the device of the user, to be used when the latter wishes to access a service.

Following the creation of the digital certificate, a message is preferably addressed to the user to inform them thereof (step 220).

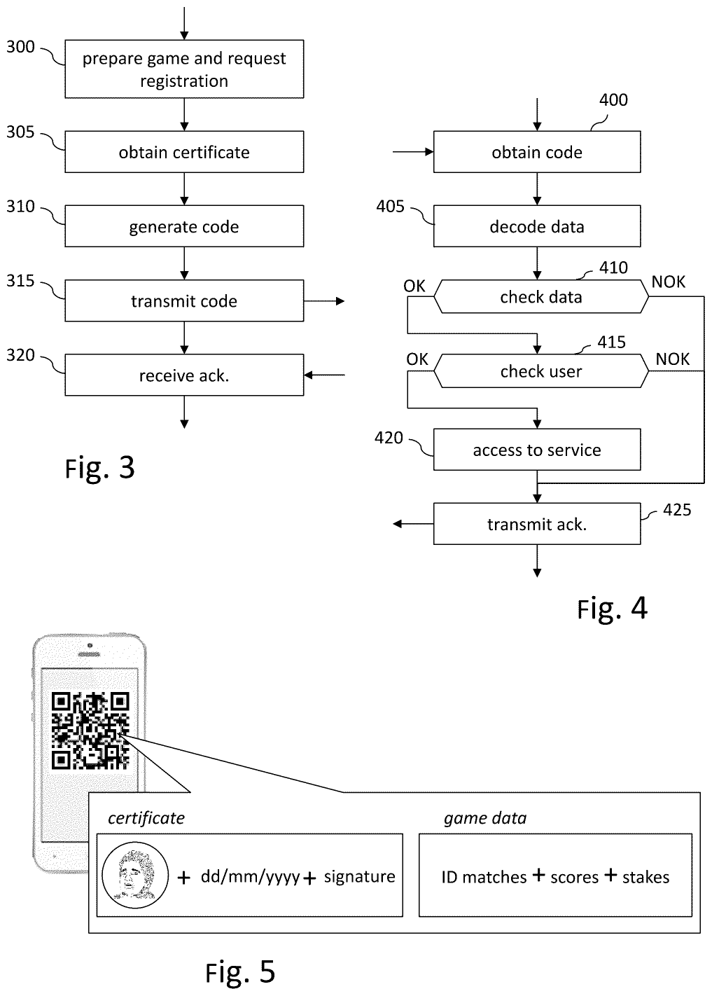

FIG. 3 illustrates an example of steps of a method for using a digital certificate for accessing a game, for example a sporting bet, according to particular embodiments of the invention, implemented in a device of a player.

As illustrated, the object of a first step (step 300) is to prepare access to a service, here to prepare a registration to a game. By way of illustration, the step can be implemented in a specific device, for example the application known by the name “Parions sport” referred to previously. The preparation of the registration to the game comprises for example the selection of one or more matches, scores or amounts of the bet or bets.

Although the steps illustrated on FIG. 3 illustrate access to a game, similar steps can be implemented to access another service, to access a product or to access a place.

In a following step, a digital certificate such as the one created at the end of the steps illustrated on FIG. 2 is sought and, where applicable, obtained (step 305). In the absence of a digital certificate, the procedure continues in the usual way (not shown). In this case, the game information is presented in a standard manner to a retailer of a retail outlet, for example in the form of a QR code, which verifies that the player is an adult and, in the affirmative, collects the amounts of the bet or bets, and records this bet or bets.

If, on the contrary, a digital certificate has been obtained, a participation code such as a QR code or a barcode is generated (step 310). It comprises here game data, for example references (or identifiers) of matches, scores and amounts of bets, as well as data of the digital certificate, for example a photograph of the player, their date of birth and a signature of the digital certificate. The format of the participation code may be specific or compliant with a standard. By way of illustration, it may be a QR in accordance with ISO/IEC 18004:2015 making it possible to code up to 4.3 KB of data.

The participation code generated is then transmitted to a terminal of an operator, for example a terminal of a retailer in a retail outlet (step 315). According to particular embodiments, this participation code is transmitted by displaying it on the device of the user and reading it by means of a reader connected to the terminal of the operator. According to other embodiments, this participation code be can be transmitted by communication means, for example near-field communication means of the NFC type (the initialism of Near Field Communication). In response to the transmission of this participation code and to the processing thereof by a remote system, a message confirming participation in the game or rejecting is preferably sent to the device of the player to inform them that their participation in the game has been registered or rejected (step 320). Such a message is for example displayed on the screen of the device of the player.

According to other embodiments that are not shown, data of the digital certificate are not transmitted from the device of the user to a terminal of an operator, for example a retailer in a retail outlet, but the user shows to the operator, on their own device, data of the digital certificate (or determined from the digital certificate), the operator then being able to simply validate the fact that the user is apparently the one that they claim to be (by comparing the photograph displayed with the face of the user), checking information, for example the age or the fact that they are adult and, where applicable, checking the origin of the digital certificate (and incidentally the validity of the density document).

FIG. 4 illustrates an example of steps of a method for using a digital certificate for giving access to a game, example a sporting bet, according to particular embodiments of the invention, implemented in a terminal of an operator, for example a terminal of a retailer in a retail outlet.

As illustrated, the object of the first step is obtaining a participation code, for example a QR code or a barcode (step 400). As described previously, such a participation code can be obtained by reading this code displayed on a device of a player or can be received by wireless communications means, for example of the NFC type. This participation code here contains game data, for example references to one or more matches, to one or more scores and to one or more amounts of bets. It furthermore comprises data of a digital certificate, for example a photograph of the player, one or more characteristics of the player, for example their date of birth, and preferably a signature or an indication of origin of the digital certificate.

In a following step, the data are extracted from the participation code (step 405). The extracted data are then preferably checked (step 410). Such a check can in particular comprise checking the signature of the digital certificate, for example by comparing the result of a hash function applied to the data of the digital certificate (with the exception of the signature) with the signature of the digital certificate received. If the data extracted from the code are not in accordance with the expected data, for example if the digital certificate is not authenticated, the procedure for registering participation in a game is ended. On the other hand, if the data extracted from the code are in accordance with the expected data, a check on the player is made (step 415).

This check can comprise the display of the photograph contained in the participation code obtained and the display of a characteristic of the player, for example whether they are adult or not, this characteristic being determined from data contained in the participation code received, for example by comparing a date of birth, a current date and the age of majority. The operator, for example the retailer of the retail outlet concerned, can then compare the photograph displayed on their terminal with the face of the player to check that the digital certificate does indeed correspond to the person who wishes to play and to check that they have the right to play, for example checking that they are adult.

If the player does not have the right to play, for example if they are a minor, the procedure for registering a participation in a game is ended. On the other hand, if they have the right to play, their participation is registered (step 420).

A message registering participation in the game or rejecting can be transmitted to the device of the player from which the code was obtained (step 425).

FIG. 5 illustrates an example of a device of a player wishing to register participation in a game, for example the device 105 in FIG. 1. According to the example illustrated, the screen of the device displays a QR code in which a digital certificate and game data are stored. The digital certificate comprises here a photograph of the player who obtained the digital certificate, their date of birth and a signature of the digital certificate. Still by way of illustration, the game data comprise references of matches, scores and amounts bet (stakes).

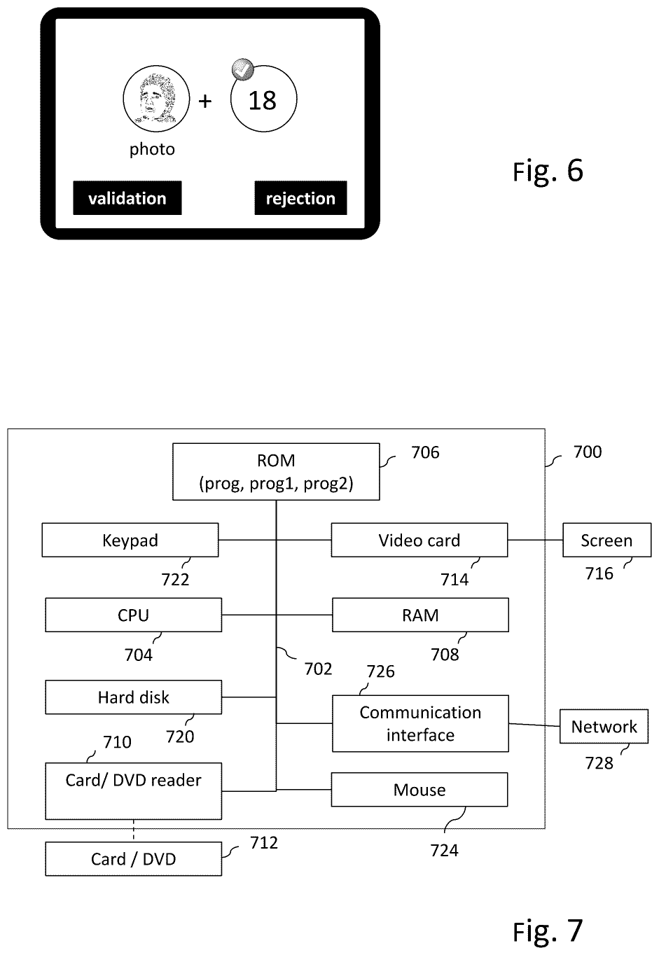

FIG. 6 illustrates an example of a screen of a terminal of an operator, for example a terminal of a retailer of a retail outlet, for example a screen of the terminal 110, used for registering participation in a game. According to the example illustrated, the screen of the terminal displays data received in a participation code transmitted by a device of a player (or determined from such data). More precisely, the screen of the terminal displays here a photograph of a player as well as an indication of majority determined from a date of birth received. From this screen, an operator can determine whether the player is the one that they claim to be (i.e. whether their face corresponds to the photograph contained in a certificate received) and whether the player has the right to play, for example whether they are adult. If so, the operator can validate the registration for the game. In the contrary case, they can reject it.

FIG. 7 illustrates an example of a device that can be used for implementing, at least partially, embodiments of the invention, in particular steps described with reference to FIGS. 2 to 4.

The device 700 is for example a server, a computer, a terminal or a personal device such as a smartphone or a tablet.

The device 700 preferably includes a communication bus 702 to which there are connected:
a central processing unit or microprocessor 704 (CPU, the initialism for Central Processing Unit);
a read only memory (ROM) 706 that can include an operating system and programs such as “Prog”;
a random access or cache memory 708 (RAM, the acronym for Random Access Memory) including registers adapted to record variables and parameters created and modified during the execution of the aforementioned programs; and
a communication interface 726 connected to a distributed communication network 728, for example a wireless communication network and/or a local communication network, the interface being able to transmit and receive data, in particular to and from a device of the user.

Optionally, the device 700 can also have available the following elements:
a hard disk 720 that can include the aforementioned programs “Prog” and data processed or to be processed according to the invention;
a keypad 722 and a mouse 724 or any other pointing device such as an optical pen, a touch screen or a remote control enabling the user to interact with the programs according to the invention;
a reader 710 for a removable storage medium 712 such as a memory card or a disc, example a DVD disk; and
a graphics card 714 connected to a screen 716.

The communication bus affords communication and interoperability between the various elements included in the device 700 or connected thereto. The representation of the bus is not limitative and in particular the central unit is able to communicate instructions to any element of the device 700 directly or by means of another element of the device 700.

The executable code of each program enabling the programmable apparatus to implement the processes according to the invention can be stored for example in the hard disk 720 or in read-only memory 706.

According to a variant, the executable code of the programs can be received by means of the communication network 728, via the interface 726, to be stored in an identical manner to that described previously.

More generally, the program or programs can be loaded into one of the storage means of the device 700 before being executed.

The central unit 704 will control and direct the execution of the instructions or portions of software code of the program or programs according to the invention, instructions that are stored in the hard disk 720 or in the read-only memory 706 or in the other aforementioned storage elements. On powering up, the program or programs that are stored in a non-volatile memory, for example the hard disk 720 or the read-only memory 706, are transferred into the random access memory 708, which then contains the executable code of the program or programs according to the invention, as well as registers for storing the variables and parameters necessary for implementing the invention.

Depending on the embodiment selected, some acts, actions, events or functions of each of the methods described in the present document may be implemented or occur in an order different from that in which they were described, or may be added, merged or not be implemented or not occur, depending on circumstances. Furthermore, in some embodiments, some acts, actions or events are implemented or occur concurrently rather than successively.

Although described through a certain number of detailed example embodiments, the method proposed and the equipment for implementing the method comprise various variants, modifications and improvements that will appear in an obvious manner to a person skilled in the art, on the understanding that these various variants, modifications and improvements form part of the scope of the invention. In addition, various aspects and features described above may be implemented together, or separately, or be substituted for one another, and all the various combinations and sub-combinations of the aspects and features form part of the scope of the invention. Furthermore, it may happen that some systems and equipment described above do not incorporate all the modules and functions described for the preferred embodiments.

1. Method for a computer aiding access to a service by a device provided with data-acquisition means and communication means, said service being accessible only subject to at least one condition, the method comprising:
obtaining, by said device, identification data of a user, from said acquisition means of said device and from an identification document, said identification data comprising at least one photograph of said user and a characteristic of said user,
transmitting, by said device, said identification data obtained to a validation system,
in response to said identification data transmitted, receiving, by said device, validation data confirming the validity of said identification document,
in response to said validation data received, creating and storing, by said device, a digital certificate, said digital certificate comprising at least one photograph of said user and said characteristic obtained,
obtaining said characteristic and said at least one photograph from said digital certificate, and
comparing said at least one photograph to a real face to validate said characteristic, said service being accessed in response to the a validation of said characteristic.

2. The method according to claim 1, further comprising obtaining, by said device, a current photograph of said user, said current photograph being obtained from said acquisition means of said device, said at least one photograph of said digital certificate being said current photograph.

3. The method according to claim 2, further comprising a transmission, by said device, of said current photograph to said validation system to verify that said user is an owner of said identity document.

4. The method according to claim 1, further comprising at least one of compressing and encoding said at least one photograph and of said characteristic of said digital certificate.

5. The method according to claim 1, further comprising calculating a signature based on at least one of said at least one photograph and said characteristic of said digital certificate by said device, said signature being added to said digital certificate.

6. The method according to claim 1, further comprising:
obtaining, by said device, data relating to said service,
encoding, by said device, said data obtained relating to said service and data of said digital certificate in an access code to provide access to said service, and
transmitting, by said device, said access code to a terminal of an operator, said terminal being configured to decode data of said access code and to display at least said at least one photograph of said digital certificate and information obtained from said characteristic of said digital certificate.

7. The method according to claim 6, further comprising displaying said access code on said device.

8. The method according to claim 6, further comprising:
receiving, by said terminal, said access code,
obtaining, in said terminal, said at least one photograph of said digital certificate encoded in said access code,
displaying, by said terminal, said at least one photograph of said digital certificate encoded in said access code and said information obtained from said characteristic of said digital certificate, and
in response to a validation, on said terminal, of an operator following said display of said at least one photograph of said digital certificate encoded in said access code and said information obtained from said characteristic of said digital certificate, providing access to said service to said user.

9. A computer program recorded on a non-transitory media executable by a processor and comprising instructions for implementing each of the steps of the method according to claim 1.

10. A device comprising a processor configured to execute each of the steps of the method according to claim 1.
